(19) United States
(12) Patent Application Publication
(10) Pub. No.: US 2009/0244045 A1
(43) Pub. Date: Oct. 1, 2009

(54) DISPLAY DEVICE AND A DRIVING METHOD OF THE DISPLAY DEVICE

(75) Inventors: Nobuyoshi SAITO, Kawasaki-Shi (JP); Tomomasa Ueda, Yokohama-Shi (JP); Yujiro Hara, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/402,043

(22) Filed: Mar. 11, 2009

(30) Foreign Application Priority Data
Mar. 26, 2008 (JP) 2008-080553

(51) Int. Cl. G06F 3/038

(52) U.S. Cl. 345/211

(57) ABSTRACT

This disclosure concerns a display device including an n-type drive transistor controlling a current flowing the light emitting element; a bias transistor; a Vt detection transistor; a capacitor; a scanning transistor, wherein before setting the first electrode of the capacitor to have the threshold voltage of the drive transistor, the bias transistor connects a first signal line to the gate of the drive transistor to apply the negative bias to the gate of the drive transistor, the scanning line driver sets the first electrode to have a higher level potential than the threshold voltage of the drive transistor, and the Vt detection transistor connects the gate to the drain of the drive transistor to set the first electrode to have the threshold voltage of the drive transistor.

### CROSS-REFERENCE TO RELATED APPLICATION

This application is based upon and claims the benefit of priority from the prior Japanese Patent Application No. 2008-80553, filed on Mar. 26, 2008, the entire contents of which are incorporated herein by reference.

### BACKGROUND OF THE INVENTION

1. Field of the Invention

The present invention is related to a display device and a driving method of the display device.

2. Related Art

Recently, attention has been paid to an organic electroluminescence (EL) display device using OLEDs (Organic light emitting diodes) that are self-luminous elements to serve as a flat display device. Since the EL display device includes the self-luminous organic EL elements, it is unnecessary to provide a backlight necessary for a liquid crystal display device. Further, the EL display device has features suited for reproducing moving images, that is, a wide image view angle and a quick response.

However, the organic EL display device has the following problems. Since the OLED is a current-driven self-luminous element, a drive TFT (Thin Film Transistor) applying a current to the OLED needs to be always in an ON-state if display of each pixel is to be kept. Due to this, with passage of time, mobility of the drive TFT deteriorates and a threshold voltage Vth of the drive TFT rises. These deteriorations in characteristics of the drive TFT cause a change in a drive current for driving the OLED while the drive TFT operates. If the drive current for the OLED changes, irregular brightnesses of pixels and afterimage (burn-in) on screen display occur while the organic EL display device operates. If a TFT made of low crystallinity silicon such as amorphous silicon (a-Si) is used as the drive TFT, the threshold voltage Vth of the drive TFT is considerably greatly shifted. Due to this, it is still difficult to put the OLED display device using the a-Si drive TFTs to practical use. Furthermore, there has been lately proposed a pixel circuit configured so that a low temperature polycrystalline polysilicon TFT is used as each drive TFT to make it possible to quickly detect the threshold voltage of the drive TFT. However, the drive TFT constituted by such a low temperature polycrystalline polysilicon TFT has the same problem of a shift in threshold voltage.

Moreover, if a gate of the drive TFT is charged for emitting light, current is applied to the gate of the drive TFT via a light emitting element or the like from a power supply. In this case, the current is applied to the light emitting element. Due to this, the light emitting element is not disadvantageously turned into a complete black state although not in a display state. Further, if the gate of the drive TFT is charged via the light emitting element or the like, voltage drop occurs. As a result, it is disadvantageously difficult to control a gate potential of the drive TFT.

### SUMMARY OF THE INVENTION

A display device according to am embodiment of the present invention including a pixel array including a plurality of display pixels each including a current-driven light emitting element, the display device comprises: a plurality of scanning lines provided to correspond to pixel rows of the pixel array, respectively; a plurality of data lines provided to correspond to pixel columns of the pixel array, respectively; an n-type drive transistor controlling a current carried from a first power supply to a second power supply via the light emitting element; a bias transistor connected between a gate of the drive transistor and a first signal line transmitting a negative bias lower than a potential of the second power supply or a positive bias higher than a threshold voltage of the drive transistor; a Vt detection transistor connected between a drain of the drive transistor and the gate of the drive transistor, the Vt detection transistor having a gate connected to the scanning lines and setting the gate of the drive transistor to have the threshold voltage of the drive transistor; a capacitor having a first electrode connected to the gate of the drive transistor, and applying a potential difference between the gate of the drive transistor and a source of the drive transistor when the light emitting element is driven to emit light; a scanning transistor connected between a second electrode of the capacitor and a data line corresponding to a selected pixel column among the plurality of data lines, the scanning transistor having a gate connected to the scanning lines and setting a potential of the corresponding data line to the second electrode; a scanning line driver applying a potential to the first signal line and the plurality of scanning lines; and a data line driver transmitting potential data to the plurality of pixel columns via the plurality of data lines, the potential data for driving the light emitting element to emit the light at a desired brightness and at a desired gradation, wherein

before setting the first electrode to have the threshold voltage, the bias transistor connects the first signal line to the gate of the drive transistor to apply the negative bias to the gate of the drive transistor,

the scanning line driver sets the first electrode to have a higher level potential than the threshold voltage of the drive transistor by raising a potential of the first signal line from the negative bias to the higher level potential, and

the Vt detection transistor connects the gate of the drive transistor to the drain of the drive transistor to set the first electrode to have the threshold voltage of the drive transistor.

A method of driving a display device according to an embodiment of the present invention, the device including a pixel array including a plurality of display pixels each including a current-driven light emitting element, wherein

the display device includes an n-type drive transistor controlling a current carried from a first power supply to a second power supply via the light emitting element; a bias transistor connected between a gate of the drive transistor and a first signal line, the first signal line transmitting a negative bias lower than a potential of the second power supply or a positive bias higher than a threshold voltage of the drive transistor; a Vt detection transistor connected between a drain of the drive transistor and the gate of the drive transistor; a capacitor having a first electrode connected to the gate of the drive transistor, and applying a potential difference to between the gate of the drive transistor and a source of the drive transistor when the light emitting element is driven to emit light; and a scanning transistor connected between a second electrode of the capacitor and a data line corresponding to a selected pixel column among a plurality of data lines, and wherein

the method of driving the display device comprises:

connecting the first signal line to the gate of the drive transistor to apply the negative bias to the gate of the drive transistor;

setting the first electrode to have a higher level potential than the threshold voltage of the drive transistor by raising a potential of the first signal line from the negative bias to the higher level potential;

connecting the gate of the drive transistor to the drain of the drive transistor to set the first electrode to have the threshold voltage of the drive transistor; and

applying a current to the light emitting element to emit the light from the light emitting element according to the potential difference between the first electrode of the capacitor and the second electrode of the capacitor.

### BRIEF DESCRIPTION OF THE DRAWINGS

FIG. 1 shows a configuration of a display device according to a first embodiment;

FIG. 2 is a timing diagram showing an operation of the first embodiment;

FIG. 3 is a circuit diagram showing a configuration of a display pixel of a display device according to a second embodiment; and

FIG. 4 is a timing diagram showing an operation of the second embodiment.

### DETAILED DESCRIPTION OF THE INVENTION

Embodiments of the present invention will be explained below in detail with reference to the accompanying drawings. Note that the invention is not limited thereto.

### First Embodiment

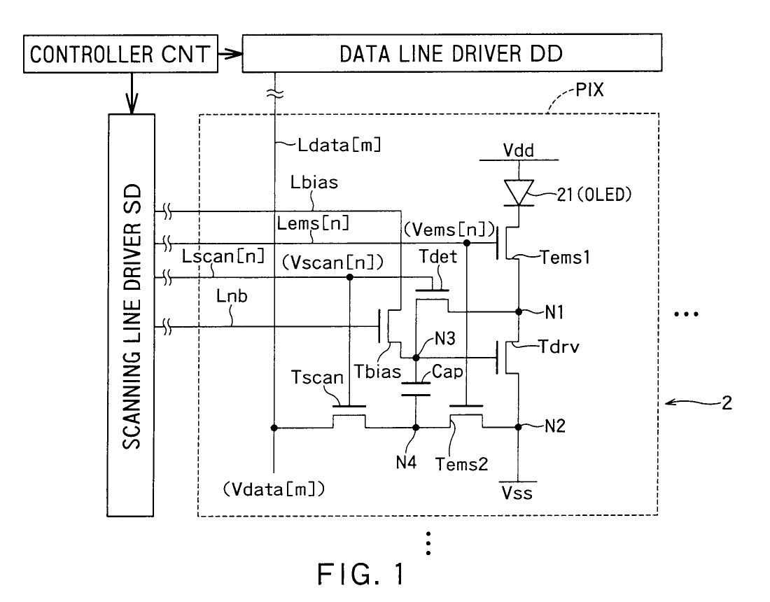

A display device according to a first embodiment shown in FIG. 1 is an active matrix display device. The display device includes a pixel array unit 2, a data line driver DD, a scanning line driver SD, and a controller CNT synchronizing the data line driver DD with the scanning line driver SD.

Although FIG. 1 shows only one display pixel PIX, the pixel array unit 2 actually includes a plurality of display pixels PIXs arranged two-dimensionally in a matrix. Each display pixel PIX includes a light emitting element 21 constituted by an OLED, a drive transistor Tdrv, two switching elements Tems1 and Tems2, a reset transistor Trst, a Vt detection transistor Tdet, a bias transistor Tbias, a capacitor Cap, and a scanning transistor Tscan.

The light emitting element 21, the first switching element Tems1, and the drive transistor Tdrv are connected in series between a first power supply Vdd and a second power supply Vss and constitute a current path. A current carried on this current path causes the light emitting element 21 to emit light. The drive transistor Tdrv is an n-TFT at least a channel part of which is made of amorphous silicon. The drive transistor Tdrv controls the current carried on the current path between the first power supply Vdd and the second power supply Vss. The drive transistor Tdrv can thereby drive the light emitting element 21 to emit light at a desired brightness and a desired gradation based on potential data received from the data line driver DD. It is assumed that a drain-side node of the drive transistor Tdrv is N1, a source-side node thereof is N2, and that a gate-side node thereof is N3.

An anode of the light emitting element 21 is connected to the first power supply Vdd and a cathode thereof is connected to a drain of the first switching element Tems1. A source of the first switching element Tems1 is connected to the node N1. That is, the first switching element Tems1 is connected between the light emitting element 21 and a drain of the drive transistor Tdrv.

The Vt detection transistor Tdet is connected between the nodes N1 and N3 and used to detect a threshold voltage of the drive transistor Tdrv. A gate of the Vt detection transistor Tdet is connected to first scanning lines Lscan[n], where n is an integer.

The bias transistor Tbias is connected between a bias line Lbias serving as a first signal line and the node N3. A gate of the bias transistor Tbias is connected to a bias control line Lnb. The bias transistor Tbias transmits a potential of the bias line Lbias to the node N3 if being conductive.

The scanning lines Lscan[n] are connected to the scanning line driver SD and provided to correspond to pixel rows of the pixel array unit 2, respectively. If the corresponding pixel row is driven, a potential of one scanning line Lscan[n] is raised to a positive potential (e.g., +10 V). In a standby state in which the corresponding pixel row is not driven, the potential of one scanning line Lscan[n] is kept to a negative potential (e.g., −10 V). The scanning lines Lscan[n] are selected (activated) in order of n.

Note that “activation” means turning on or driving an element or a circuit and that “deactivation” means turning off or stopping an element or a circuit. Accordingly, a HIGH (high level potential) signal is an activation signal on one occasion and a LOW (low level potential) signal is an activation signal on another occasion. For example, an NMOS transistor is activated by making a gate thereof HIGH. A PMOS transistor is activated by making a gate thereof LOW.

A first electrode and a second electrode of the capacitor Cap are connected to nodes N3 and N4, respectively. That is, the capacitor Cap interposes between the gate (N3) and the source (N2) of the drive transistor Tdrv. The second switching element Tems2 is connected between the nodes N4 and N2. That is, the second switching element Tems2 is connected between the second electrode of the capacitor Cap and the source of the drive transistor Tdrv. The scanning transistor Tscan is connected between the node N4 and one data line Ldata[m] propagating data, where m is an integer. The capacitor Cap applies a potential difference to between the gate (N3) and the source (N2) of the drive transistor Tdrv if the light emitting element 21 is driven to emit light.

The data lines Ldata[m] are connected to the data line driver DD and provided to correspond to pixel columns of the pixel array unit 2, respectively. Each of the data lines Ldata[m] transmits potential data for driving the light emitting element 21 to emit light at the desired brightness and the desired gradation to the corresponding pixel column.

Gates of the Vt detection transistor Tdet and the scanning transistor Tscan are connected to one first scanning line Lscan[n] selecting the display pixel PIX including the Vt detection transistor Tdet and the scanning transistor Tscan in common. Accordingly, the Vt detection transistor Tdet and the scanning transistor Tscan operate at the same timing.

The first and second switching elements Tems1 and Tems2 are controlled by a signal Vems propagated on one switching line Lems. The signal Vems is a signal activated if a current is applied to the light emitting element 21 to drive the light emitting element 21 to emit light. That is, the first and second switching elements Tems1 and Tems2 are switches that are turned conductive if the light emitting element 21 emits light at the voltage held in the capacitor Cap.

The scanning line driver SD is configured to drive the bias lines Lbias, the scanning lines Lscan, the bias control lines Vnb, and the switching lines Lems.

With the above configuration, the display device according to the first embodiment applies a negative potential of the bias line Lbias to the gate of the drive transistor Tdrv before the potential difference for driving the light emitting element 21 to emit light is held in the capacitor Cap. It is thereby possible to return a shifted threshold voltage of the drive transistor Tdrv to an original threshold voltage Vth.

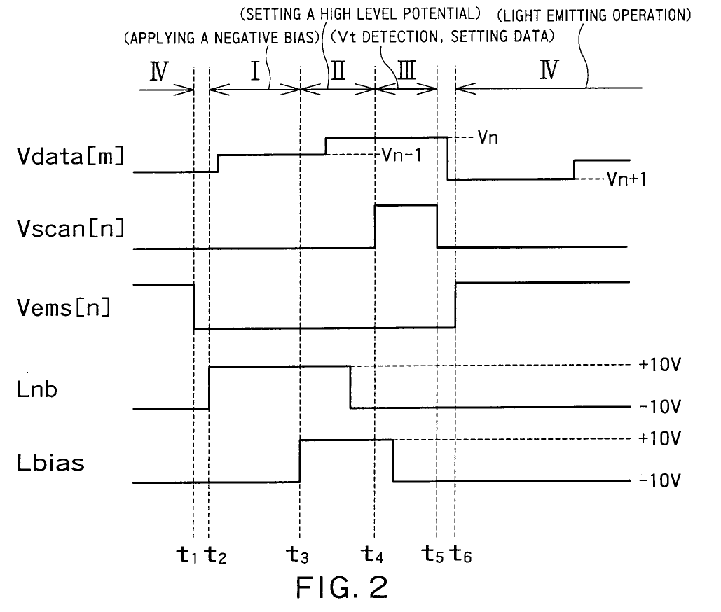

With reference to FIG. 2, an operation performed by the display device according to the first embodiment will be described. FIG. 2 shows only operation performed by one display pixel PIX. Since operations performed by the other display pixels PIXs can be easily estimated from FIG. 2, they are not described herein.

Before t1, the scanning line driver SD selects a scanning line Lscan[n−1]. At this time, the scanning line Lscan[n] has a low level potential (−10 V). In the first embodiment, a high level potential of the scanning line Lscan[n] is set to +10 V and a low level potential thereof is set to −10 V. However, the potentials of the scanning lines Lscan[n] are not limited thereto. Nevertheless, the low level potential of the scanning line Lscan[n] needs to be negative so as to recover the threshold voltage Vth of the drive transistor Tdrv.

At t1, the scanning line driver SD deactivates the potential Vems[n] of the switching line Lems[n] to the low level potential. The first and second switching elements Tems1 and Tems2 are thereby turned off and a frame selected just previously finishes its light emitting operation.

Right after t1, the scanning line driver SD raises the potential of the bias control line Lnb to the high level potential. The bias transistor Tbias is turned conductive and applies a potential Vbias to the gate of the drive transistor Tdrv. At this time, the bias line Lbias is negatively biased. As a result, a negative bias is applied to the gate of the drive transistor Tdrv (node N3) and the threshold voltage of the drive transistor Tdrv returns to the original threshold voltage Vth. In this way, by applying the negative bias to the gate of the drive transistor Tdrv, the threshold voltage of the drive transistor Tdrv dropped when previously driving the light emitting element 21 can be raised to be close to the original threshold voltage Vth.

Conventionally, to recover the threshold voltage of the drive transistor Tdrv, a transistor diode-connected to the drive transistor Tdrv is connected between a negative bias power supply and the gate of the drive transistor Tdrv. In this case, if the gate potential of the drive transistor Tdrv is closer to the potential of the negative bias power supply, a gate potential response is slower because of diode characteristics. In the first embodiment, however, the negative bias is directly connected to the gate of the drive transistor Tdrv without via a diode. The gate potential can be, therefore, suddenly dropped. That is, in the first embodiment, a shift in the threshold voltage of the drive transistor Tdrv due to the application of the negative bias can be corrected in short time.

At t3, the scanning line driver SD raises the potential of the bias line Lbias to the high level potential while the potential of the bias control line Lnb is kept the high level potential. The potential of the node N3 thereby rises to the high level potential according to the rising of the bias line Lbias. At this time, the potential of the node N3 is precharged to a higher potential than the threshold voltage of the drive transistor Tdrv. Since the switching element Tems1 is turned off at this time, no current is applied to the light emitting element 21.

Conventionally, the gate of the drive transistor Tdrv (a first electrode of the capacitor Cap) is charged from the first power supply Vdd via the light emitting element 21 and the switching element Tems1. It is, therefore, difficult to control the gate potential of the drive transistor Tdrv due to the voltage drop caused by the light emitting element 21 and the switching element Tems1. Furthermore, if the switching element Tems1 is turned off, current passes through the switching element Tems 1, thereby making it disadvantageously more difficult to control the gate potential of the drive transistor Tdrv. Besides, since the current is carried across the slight emitting element 21, the light emitting element 21 is not turned into a complete black state although not in a display state.

In the first embodiment, by contrast, the conventional problems do not occur and the gate of the drive transistor Tdrv can be charged at a desired potential. Further, in the first embodiment, no current is carried across the light emitting element 21, so that that the light emitting element 21 can be set in a high quality black state in standby. By setting the precharge potential of the node N3 high, the threshold voltage of the drive transistor Tdrv can be returned to the original threshold voltage Vth even if the threshold voltage is greatly shifted.

At t4, the scanning line driver SD raises the potential Vscan[n] of the scanning line Lscan[n]. The Vt detection transistor Tdest and the scanning transistor Tscan are simultaneously turned conductive. The potential difference between the nodes N3 and N2 exceeds the threshold voltage Vth of the drive transistor Tdrv. Due to this, if the Vt detection transistor Vdet is turned conductive, then the drive transistor Tdrv is turned conductive accordingly, and the node N3 is connected to the second power supply potential Vss via the node N1 and the drive transistor Tdrv. If the potential of the node N3 drops to the threshold voltage Vth of the drive transistor Tdrv, the drive transistor Tdrv is turned nonconductive. The potential of the node N3 (potential of the first electrode of the capacitor Cap) is thereby set to a potential almost equal to the threshold voltage Vth of the drive transistor Tdrv. Since the threshold voltage of the drive transistor Tdrv is already returned to the original threshold voltage Vth during the period from t2 to t3, the potential of the node N3 is set to the original threshold voltage Vth of the drive transistor Tdrv. Note that the high level potential of the bias line Lbias needs to be higher than the threshold voltage Vth of the drive transistor Tdrv.

If the scanning transistor Tscan is turned conductive, the potential Vn of the data line Tdata[m] is set to the node N4 (a second electrode of the capacitor Cap). The potential Vn is potential data for driving the light emitting element 21 of the currently selected pixel PIX to emit light at the desired brightness and at the desired gradation. Note that Vn−1 is potential data applied to the pixel PIX connected to the scanning line Lscan[n+1] selected next to the scanning line Lscan[n].

As can be seen, in the first embodiment, the threshold voltage Vth is set to the first electrode of the capacitor Cap and the potential data is simultaneously set to the second electrode of the capacitor Cap. The display device according to the first embodiment can operate at high speed.

At t5, the scanning line drive SD lowers the scanning line Vscan[n]. By falling of the scanning line Vscan[n], the Vt detection transistor Vdet and the scanning transistor Tscan are turned nonconductive. Therefore, the node N4 is kept in a state of being set to the desired potential Vn. Further, the node N3 is kept in a state of being set to the threshold voltage Vth. The potential of the first electrode of the capacitor Cap (the potential of the node N3) is kept Vn and the potential of the second electrode (potential of the node N4) is kept Vth. That is, the potential difference held in the capacitor Cap is (Vth-Vn). The potential difference (Vth-Vn) held in the capacitor Cap is used to cause the light emitting element 21 to emit light.

Right after t5, the data line driver DD changes the potential Vdata of the data line Ldata from the potential Vn to the next potential Vn+1.

As can be seen, in the first embodiment, while the bias line Lbias has a low level potential (a negative bias), this negative bias is applied to the gate of the drive transistor Tdrv, thereby recovering the threshold voltage Vth of the drive transistor Vdrv. Next, if the bias line Lbias rises, the potential of the node N3 is raised to the high level potential. Thereafter, the Vt detection transistor Tdet is driven to set the threshold voltage Vth of the drive transistor Tdrv to the node N3.

Subsequently, at t6, the scanning line driver SD raises the potential Vems[n] of the switching line Lems[n] to the high level potential, turning on the first and second switching elements Tems1 and Tems2. The node N4 is thereby connected to the node N2 and the potential difference between the gate and the source of the drive transistor Tdrv (potential difference between the nodes N2 and N3) is equal to (Vth+Vn). Further, the light emitting element 21 is connected to the drain of the drive transistor Tdrv. As a result, the drive transistor Tdrv applies a current based on the potential difference (Vth+Vn) to the light emitting element 21 and the light emitting element 21 emits light at brightness and at gradation based on this current.

According to the first embodiment, the shifted threshold voltage of the drive transistor Tdrv can be returned to the original threshold voltage (threshold voltage before shift) Vth using the negative bias of the bias line Lbias. Furthermore, according to the first embodiment, when the potential of the bias line Lbias changes from the low level potential to the high level potential, the higher potential than the threshold voltage Vth of the drive transistor Tdrv is set to the first electrode of the capacitor Cap (node N3) using the potential rise of the bias line Lbias. Thereafter, by driving the Vt detection transistor Tdet, the threshold voltage Vth of the drive transistor Tdrv can be set to the first electrode of the capacitor Cap (node N3). At the same time, the desired potential data Vn is set to the second electrode of the capacitor Cap (node N4).

In this way, according to the first embodiment, the threshold voltage of the drive transistor can be recovered, the drain voltage of the drive transistor can be reset, and the threshold voltage of the drive transistor can be set to one end of the capacitor at high speed. By applying the first embodiment to the active matrix display device, a display device kept to have stable display quality for long time can be realized.

### Second Embodiment

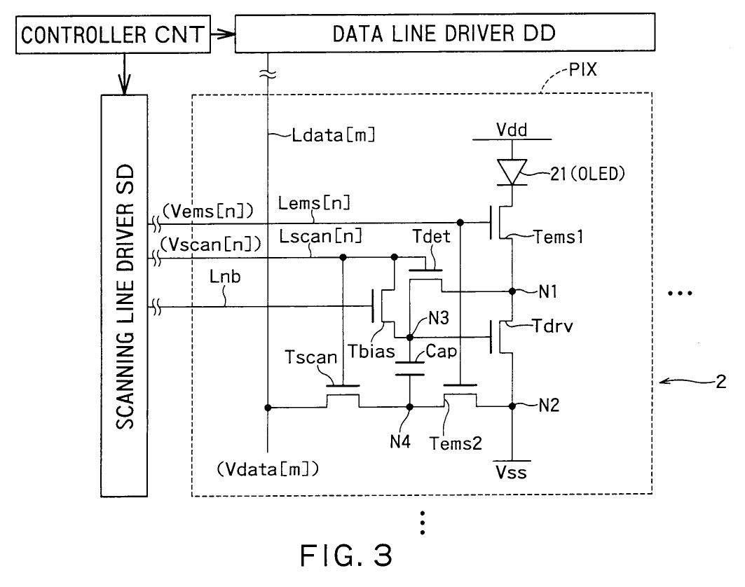

In a display device according to a second embodiment of the present invention shown in FIG. 3, the currently selected scanning line Lscan[n] applies a negative bias to the gate of the drive transistor Tdrv. In the second embodiment, therefore, the bias line Lbias is not provided. A drain of the bias transistor Tbias is connected to the scanning line Lscan[n]. Other configurations of the second embodiment can be identical to those of the first embodiment.

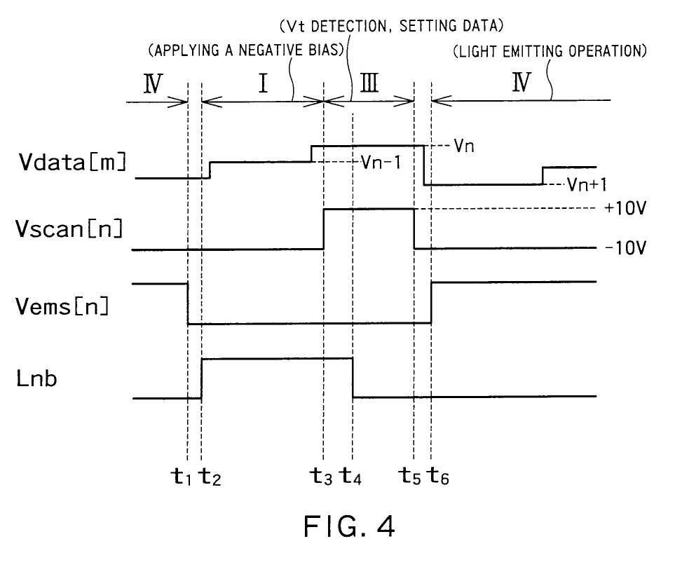

FIG. 4 shows an operation performed by the display device according to the second embodiment. Before t1, the scanning line driver SD selects the scanning line Lscan[n−1]. At this time, the scanning line Lscan[n] has a low level potential (−10 V).

At t1, the scanning line driver SD deactivates the potential Vems[n] of the switching line Lems[n] to a low level potential. A frame selected just before the scanning line Lscan[n] finishes its light emitting operation.

At t2 right after t1, the scanning line driver SD raises the potential of the bias control line Lnb to a high level potential. The bias transistor Tbias is thereby turned conductive to apply the potential of the scanning line Lscan[n] to the gate of the drive transistor Tdrv. At this time, the scanning line Lscan[n] is negatively biased. As a result, a negative bias is applied to the gate of the drive transistor Tdrv (node N3) and the threshold voltage of the drive transistor Tdrv is returned to the original threshold voltage Vth.

At t3, the scanning line driver SD raises the potential of the scanning line Lscan[n] to the high level potential while keeping the potential of the bias control line Lnb to be equal to the high level potential. The potential of the node N3 is to rise to the high level potential to follow rising of the scanning line Lscan[n]. At this time, however, the Vt detection transistor Tdet and the scanning transistor Tscan are simultaneously turned conductive. If the potential of the node N3 is to rise to the higher potential than the threshold voltage of the drive transistor Tdrv to follow the conductive state of the Vt detection transistor Tdet, then the drive transistor Tdrv is turned conductive and the node N3 is connected to the second power supply potential Vss via the node N1 and the drive transistor Tdrv. Therefore, the potential of the node N3 (potential of the first electrode of the capacitor Cap) is almost equal to the threshold voltage Vth of the drive transistor Tdrv. Since the threshold voltage of the drive transistor Tdrv is already returned to the original threshold voltage Vth during the period from t2 to t3, the potential of the node N3 is set to the original threshold voltage Vth of the drive transistor Tdrv. Note that the high level potential of the scanning line Lscan[n] needs to be higher than the threshold voltage Vth of the drive transistor Tdrv.

If the scanning transistor Tscan is turned conductive, the potential Vn of the data line Tdata[m] is set to the node N4 (the second electrode of the capacitor Cap).

At t4, the scanning line driver SD reduces the potential of the bias control line Lnb to the low level potential. The bias transistor Tbias is thereby turned nonconductive and the potential of the node N3 (potential of the first electrode of the capacitor Cap) is set to the threshold voltage Vth of the drive transistor Tdrv.

Since the operation performed by the display device according to the second embodiment at and after t5 is similar to that according to the first embodiment, it will not be described herein.

The display device according to the second embodiment uses the scanning line Lscan[n] to apply a negative bias to the gate of the drive transistor Tdrv. The display device according to the second embodiment can, therefore, dispense with the bias line Lbias. As a result, a circuit configuration of each pixel PIX and a configuration of the scanning line driver SD can be made relatively simple. Moreover, according to the second embodiment, the potential of the node N3 is set to the threshold voltage Vth of the drive transistor Tdrv without temporarily setting the potential of the node N3 to the high level potential. The display device according to the second embodiment can, therefore, realize high-speed Vth detection. That is, according to the second embodiment, the potential of the first electrode of the capacitor Cap (the potential of the node N3) can be set equal to the threshold voltage Vth of the drive transistor Tdrv.

Besides, the second embodiment can also exhibit the advantages of the first embodiment.

In the above embodiments, each display element is the OLED. However, the display element according to the present invention is not limited to the OLED but an arbitrary current-driven light emitting element the luminous brightness of which changes according to a current value such as a charge-injection electrochemical light emitting element can be used as the display element.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A display device including a pixel array including a plurality of display pixels each including a current-driven light emitting element, comprising:
a plurality of scanning lines provided to correspond to pixel rows of the pixel array, respectively;
a plurality of data lines provided to correspond to pixel columns of the pixel array, respectively;
an n-type drive transistor controlling a current carried from a first power supply to a second power supply via the light emitting element;
a bias transistor connected between a gate of the drive transistor and a first signal line transmitting a negative bias lower than a potential of the second power supply or a positive bias higher than a threshold voltage of the drive transistor;
a Vt detection transistor connected between a drain of the drive transistor and the gate of the drive transistor, the Vt detection transistor having a gate connected to the scanning lines and setting the gate of the drive transistor to have the threshold voltage of the drive transistor;
a capacitor having a first electrode connected to the gate of the drive transistor, and applying a potential difference between the gate of the drive transistor and a source of the drive transistor when the light emitting element is driven to emit light;
a scanning transistor connected between a second electrode of the capacitor and a data line corresponding to a selected pixel column among the plurality of data lines, the scanning transistor having a gate connected to the scanning lines and setting a potential of the corresponding data line to the second electrode;
a scanning line driver applying a potential to the first signal line and the plurality of scanning lines; and
a data line driver transmitting potential data to the plurality of pixel columns via the plurality of data lines, the potential data for driving the light emitting element to emit the light at a desired brightness and at a desired gradation, wherein
before setting the first electrode to have the threshold voltage, the bias transistor connects the first signal line to the gate of the drive transistor to apply the negative bias to the gate of the drive transistor,
the scanning line driver sets the first electrode to have a higher level potential than the threshold voltage of the drive transistor by raising a potential of the first signal line from the negative bias to the higher level potential, and
the Vt detection transistor connects the gate of the drive transistor to the drain of the drive transistor to set the first electrode to have the threshold voltage of the drive transistor.

2. The display device according to claim 1, wherein
simultaneously with setting the first electrode to have the threshold voltage of the drive transistor, the scanning transistor connects the data line to the second electrode to set the second electrode to have the potential of the data line.

3. The display device according to claim 1, wherein
the gate of the Vt detection transistor, the gate of the scanning transistor, and the first signal line are connected to the first scanning line corresponding to a selected pixel row.

4. The display device according to claim 1, wherein
the drive transistor is an n-type amorphous silicon transistor having a channel part made of amorphous silicon.

5. The display device according to claim 2, wherein
the drive transistor is an n-type amorphous silicon transistor having a channel part made of amorphous silicon.

6. The display device according to claim 3, wherein
the drive transistor is an n-type amorphous silicon transistor having a channel part made of amorphous silicon.

7. The display device according to claim 1, further comprising:
a first switching element connected between the light emitting element and the drain of the drive transistor; and
a second switching element connected between the second electrode of the capacitor and the source of the drive transistor, wherein
the bias transistor is set conductive to apply the negative bias to the gate of the drive transistor,
the first signal line is raised to have the higher level potential than the threshold voltage of the drive transistor while keeping the bias transistor conductive to set the second electrode of the capacitor to have the higher level potential,
the potential data is set to the second electrode of the capacitor by making the scanning transistor conductive,
the first electrode of the capacitor is set to have the threshold voltage of the drive transistor by making the Vt detection transistor conductive, and
the drive transistor applies a current to the display pixels according to the potential difference held in the capacitor by making the first switching element and the second switching element conductive.

8. A method of driving a display device including a pixel array including a plurality of display pixels each including a current-driven light emitting element, wherein
the display device includes
an n-type drive transistor controlling a current carried from a first power supply to a second power supply via the light emitting element;
a bias transistor connected between a gate of the drive transistor and a first signal line, the first signal line transmitting a negative bias lower than a potential of the second power supply or a positive bias higher than a threshold voltage of the drive transistor;
a Vt detection transistor connected between a drain of the drive transistor and the gate of the drive transistor;
a capacitor having a first electrode connected to the gate of the drive transistor, and applying a potential difference to between the gate of the drive transistor and a source of the drive transistor when the light emitting element is driven to emit light; and
a scanning transistor connected between a second electrode of the capacitor and a data line corresponding to a selected pixel column among a plurality of data lines, and wherein
the method of driving the display device comprises:
connecting the first signal line to the gate of the drive transistor to apply the negative bias to the gate of the drive transistor;
setting the first electrode to have a higher level potential than the threshold voltage of the drive transistor by raising a potential of the first signal line from the negative bias to the higher level potential;
connecting the gate of the drive transistor to the drain of the drive transistor to set the first electrode to have the threshold voltage of the drive transistor; and
applying a current to the light emitting element to emit the light from the light emitting element according to the potential difference between the first electrode of the capacitor and the second electrode of the capacitor.

9. The display device according to claim 8, wherein
simultaneously with setting the first electrode to have the threshold voltage of the drive transistor, the scanning transistor connects the data line to the second electrode to set the second electrode to have the potential of the data line.

10. The display device according to claim 9, wherein
the gate of the Vt detection transistor, the gate of the scanning transistor, and the first signal line are connected to the first scanning line corresponding to a selected pixel row.

11. The display device according to claim 8, wherein
the drive transistor is an n-type amorphous silicon transistor having a channel part made of amorphous silicon.

12. The display device according to claim 9, wherein
the drive transistor is an n-type amorphous silicon transistor having a channel part made of amorphous silicon.

13. The display device according to claim 10, wherein
the drive transistor is an n-type amorphous silicon transistor having a channel part made of amorphous silicon.
